(19) United States
(12) Patent Application Publication
(10) Pub. No.: US 2007/0237424 A1
(43) Pub. Date: Oct. 11, 2007

(54) Method and apparatus instrumenting a camera to: measure, model and insert target objects at their right size into pictures

(75) Inventors: Bernard Burg, Menlo Park, CA (US); Philippe Morin, Goleta, CA (US); Kevin Kenji Takagi, Cupertino, CA (US)

Correspondence Address: RATNERPRESTIA, P.O. BOX 980, VALLEY FORGE, PA, 19482, US

(73) Assignee: Matsushita Electric Industrial Co., Ltd.

(21) Appl. No.: 11/391,858

(22) Filed: Mar. 29, 2006

(51) Int. Cl. G06K 9/36

(52) U.S. Cl. 382/286

(57) ABSTRACT

Apparatus and methods are provided for measuring a size of an object in a field of view of a captured image. A distance is measured from a focal point of the image to the object. A cursor is fit to the object and the size of the object is estimated based on processing the measured distance, image parameters and the cursor. Alternatively, a model having dimensions corresponding to the object boundaries is fit to the object boundaries. At least one dimension is estimated from among the dimensions of the fitted model. The size of the object is estimated by determining the dimensions based on the estimated dimension, image parameters and the fitted model.

### FIELD OF THE INVENTION

The present invention relates to the field of digital imaging and, more particularly, to methods and apparatus for measuring an object size in a field of view of an image.

### BACKGROUND OF THE INVENTION

Digital cameras are well known in the art and may be stand alone products or be embedded in other products such as wireless telephones. Digital images may be used to communicate personal events as well as for professional applications. Digital images can be used, for example, to catalogue personal possessions as well for advertising objects for sale.

Digital images allow the insertion of a date. Objects in digital images may also be selected and inserted into other pictures. Digital images, however, provide a limited amount of information. For example, it may be possible to estimate the size of an object when the digital image includes a reference object having a known size, such as a ruler. If the object is inserted in another picture or a reference is not known, however, it may be difficult to judge the size of the object.

### SUMMARY OF THE INVENTION

The present invention is embodied in an apparatus and method for measuring a size of an object in a field of view of an image having image parameters. The apparatus and method capture the image including the object, measure a distance from a focal point to the object and fit a cursor to the object. The apparatus and method further process the measured distance, the image parameters and the cursor to estimate the size of the object.

The present invention is also embodied in an apparatus and method for measuring a size of an object in a field of view of an image having image parameters using a model. The apparatus and method capture the image including the object and fit the model of the object to boundaries of the object. The fitted model has dimensions corresponding to the boundaries of the object. The apparatus and method further estimate at least one dimension among the dimensions of the fitted model. The dimensions of the fitted model are determined based on the estimated at least one dimension, the image parameters and the fitted model to estimate the size of the object.

### BRIEF DESCRIPTION OF THE DRAWINGS

The invention is best understood from the following detailed description when read in connection with the accompanying drawings. It is emphasized that, according to common practice, various features/elements of the drawings may not be drawn to scale. On the contrary, the dimensions of the various features/elements may be arbitrarily expanded or reduced for clarity. Moreover in the drawings, common numerical references are used to represent like features/elements. Included in the drawing are the following figures:

FIG. 1 is a functional block diagram illustrating an exemplary apparatus for measuring a size of an object in a field of view of an image according to the present invention;

FIG. 2 is a conceptual representation of a method for detecting a distance to an object using a telemetry sensor, according to an embodiment of the present invention;

FIG. 3 is a flowchart illustrating an exemplary method for measuring a size of an object in a field of view of an image according to the present invention;

FIGS. 4A, 4B, 4C, 4D and 4E illustrate an example of measuring the size of an object according to the exemplary method shown in FIG. 3;

FIGS. 5A, 5B and 5C illustrate a further example of measuring the size of an object according to the exemplary method shown in FIG. 3;

FIG. 6 illustrates an example of measuring sizes for a plurality of objects according to the exemplary method shown in FIG. 3;

FIG. 7 is a flowchart illustrating another exemplary method for measuring a size of an object in a field of view of an image according to the present invention;

FIG. 8 illustrates an example of estimated planes corresponding to an object according to the exemplary method shown in FIG. 7;

FIGS. 9A, 9B, 9C and 9D illustrate an example of measuring a size of an object according to the exemplary method shown in FIG. 7;

FIGS. 10A and 10B illustrate an example of providing a scale relative to an object using the estimated size of the object according to the exemplary method shown in FIG. 7; and

FIGS. 11A, 11B, 11C and 11D illustrate an example of embedding an object of a further image in a stored image such that the scale of the object corresponds to the dimensions of the image, using the exemplary method shown in FIG. 7.

### DETAILED DESCRIPTION OF THE INVENTION

The present invention describes methods and apparatus for capturing an instrumented image of an object such that a size of one or more objects in the image may be measured. In one embodiment, a cursor is fitted to the object in the image. The cursor size as well as a telemetry distance to the object and imaging parameters are used to determine the size of the object in the image. In another embodiment, a model is fitted to the boundaries of the object in the image. One or more of the model dimensions may be estimated. Alternatively, a telemetry distance corresponding to one or more of the dimensions of the model may be used to estimate one or more dimensions. The telemetry distance, as well as the model and imaging parameters may be used to estimate the corresponding one or more dimensions of the model. The remaining model dimensions may be calculated from the estimated dimensions in order to estimate the size of the object. According to the present invention, the estimated size of the object may be displayed along with the picture as well as being stored with the picture.

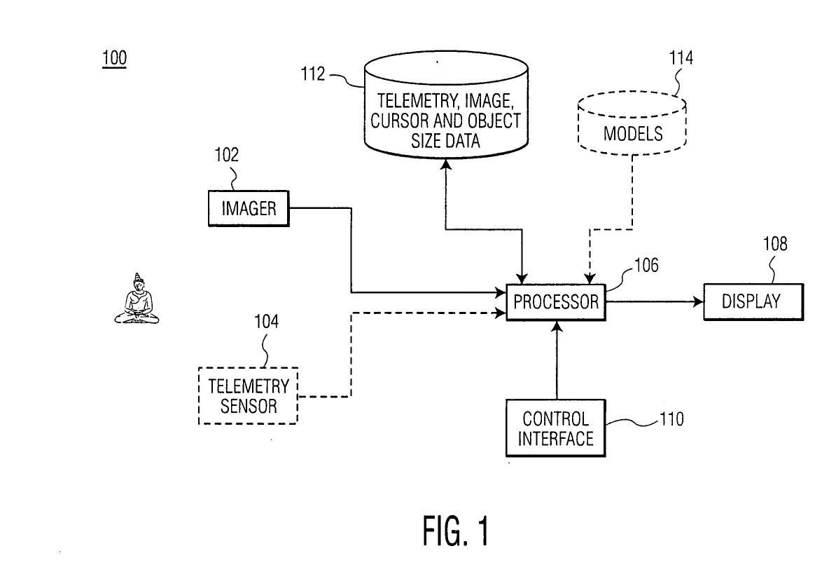

FIG. 1 is a functional block diagram illustrating an exemplary apparatus 100 for measuring a size of an object in a field of view of an image, according to an embodiment of the present invention. System 100 desirably includes an imager 102 configured to capture an image including an object in the field of view of the image. A telemetry sensor 104 may also be included in exemplary system 100 to measure a distance from a focal point to the object.

System 100 may also include a control interface 110 for entering information associated with the object in the captured image. For example, an estimated object dimension or the selection of the object may be entered using control interface 110.

The captured image from imager 102, a measured distance from telemetry sensor 104 and entered information from control interface 110 may be provided to a processor 106. Processor desirably determines a size of the object in the captured image using the information from imager 102, optional telemetry sensor 104 and control interface 110. Processor 106 may further control information presented on a display 108.

Exemplary system 100 may optionally include a model database 114 for storing geometrical models of an object. Processor 106 may fit one of the models in model database 114 to the object in the captured image. It is contemplated that the model database 114 may be capable of being updated with new geometrical models, for example, through the control interface 110 or through another interface (not shown) such as a universal serial bus (USB) port.

Exemplary system 100 may further include storage means for storing the captured image from imager 102, the telemetry data from telemetry sensor 104, cursor size information (discussed below) and the estimated size of the object. The telemetry data, cursor size information, and/or the estimated size information may be further provided with the image to a remote device or location capable of reading image files, for example, a remote computer, a wireless phone or a website. The telemetry data, cursor size information and/or the estimated size information may be included in the image file, for example, as meta-data, such as in a JPEG header format.

In an exemplary embodiment, system 100 includes a digital camera (i.e. imager 102) having a viewfinder and a liquid crystal display (LCD) (i.e. display 108). The exemplary system 100 further includes a telemetry sensor 104 desirably provided with the digital camera to measure the distance between the focal point of the imager 102 and the object. The digital camera desirably includes a processor 106 to estimate the size of the object and a control interface 110, such as for a pointing device to enter information associated with the object. The digital camera further includes storage means 112 and may optionally include model database 114. All processing is desirably performed in the exemplary system, i.e. the digital camera having processor 106.

Although an exemplary embodiment describes the imager 102 as a digital camera, it is contemplated that other imager devices, such as an infrared imager or a sonic imager may be used. It is contemplated that any device capable of capturing an image of an object may be used. The imager 102 may also include a zoom function. The imager 102 may include imaging parameters such as a lens focal length and a zoom factor. It is contemplated that the imaging parameters used by the imager are known when determining the size of the object in the captured image.

It is contemplated that storage means 112 may be a memory, a magnetic disk, a database or a further storage means on a remote device. Processor 106 may include electronic components and software for performing at least part of the functions of estimating the object size, configuring the display 108 responsive to the captured image from imager 102, telemetry sensor 104 and control interface 110, retrieving models from model database 114 and storing processed information in storage means 112.

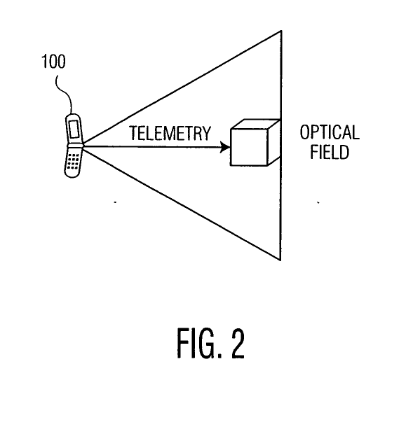

It is contemplated that telemetry sensor 104 may be an optical sensor, a laser sensor or a ultrasonic sensor or any sensor capable of measuring a distance to an object. FIG. 2 is a conceptual representation of a method for measuring a distance to an object using a telemetry sensor 104, according to an embodiment of the present invention. As shown in FIG. 2, the telemetry sensor 104 in exemplary system 100 may measure the distance from the imager to a front surface of the object. The telemetry sensor 104 is directed toward the optical field of the imager 102. When the object is in the field of view of the image, the processor 106 may use this measurement to the front of the object to estimate the size of the object, as described further below.

In an exemplary embodiment, display 108 may be a viewfinder or a LCD display of a digital camera. It is contemplated that display 108 may include any display capable of presenting other information, for example, captured image information as well as a cursor or fitted model, superimposed on the captured image. It is contemplated that display 108 may include a touch-screen display for directly manipulating a cursor or fitted model on an object in the image.

Control interface 110 may include a pointing device type interface for adjust a cursor or a model of the object over the object in the captured image. Control interface 110 may further include a text interface for entering estimated object dimensions or predetermined target object dimensions (discussed below). It is contemplated that control interface may be configured to connect to a global information network, i.e. the Internet, for obtaining data such as estimated object dimensions and geometrical models. A suitable imager 102, telemetry sensor 104, processor 106, control interface 110, display 108, storage means 112 and model database 114 for use with the present invention will be understood by one of skill in the art from the description herein.

Object Size Measurement Using Adjustable Cursor

Referring back to FIG. 1, in an exemplary embodiment, the display 108 desirably presents the captured image from imager 102 and a cursor (not shown) having a size and a position that are each adjustable for designating at least a portion of the object. The size and/or the position of the cursor may be adjusted on the display by the processor 106 responsive to a command provided by the control interface 110. The cursor is desirably adjustable in at least one dimension.

The control interface 110 may provide a selection for at least one of the type of cursor, a transparency of the cursor and a dimensionality of the cursor. It is contemplated that the cursor may be one-dimensional, two-dimensional or three-dimensional. It is further contemplated that the cursor may be of a type including a rectangle, a circle or a cross. It is further contemplated that the cursor may be presented as transparent, semi-transparent or opaque.

It is contemplated that the processor 106 may include an object fitting algorithm to determine a shape of the object. For example, a Selkow automaton may be used (see S. M. Selkow “One-Pass Complexity of Digital Picture Properties,” Journal of the ACM, 19(2) pp 283-295, April 1972). The processor 106 may adjust a shape of the cursor to correspond to the determined shape of the object.

In an exemplary embodiment, system 100 includes the telemetry sensor 104 and the processor 106 desirably processes the measured distance from telemetry sensor 104, the size of the cursor is adjusted using the control interface 110 and the known image parameters from imager 102 to estimate the size of the object. The processor 106 may further configure the display 108 to display the estimated size of the object superimposed on the captured image. Optionally, the captured image from imager 102, the measured distance from telemetry sensor 104, the estimated size processed in processor 106 and the size of the cursor adjusted responsive to the control interface 110 may be provided to storage means 112.

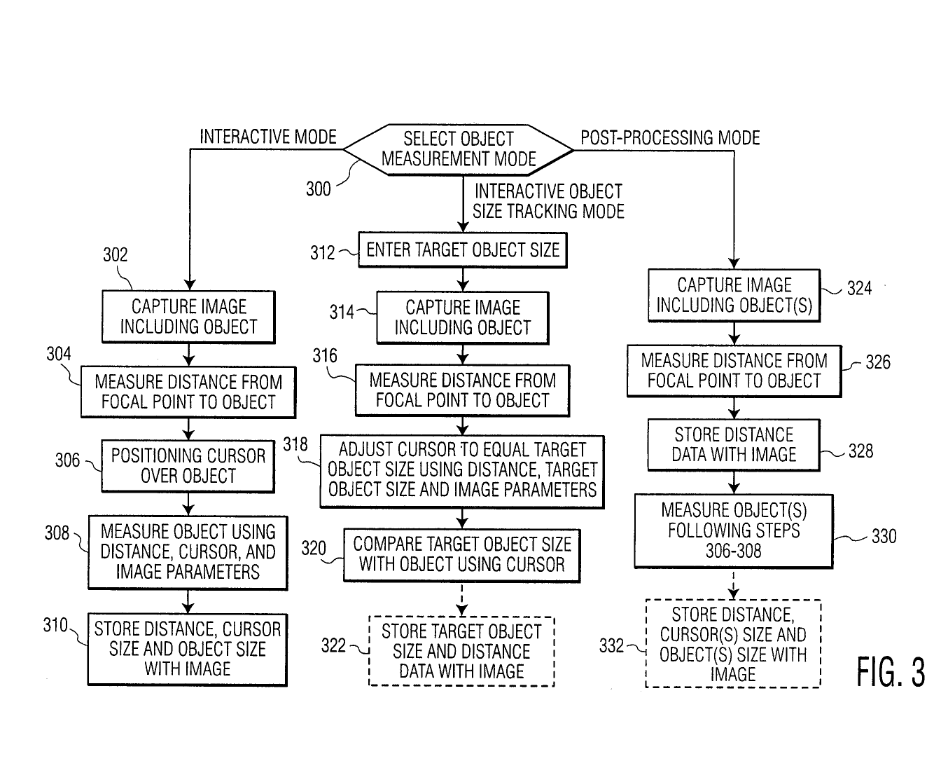

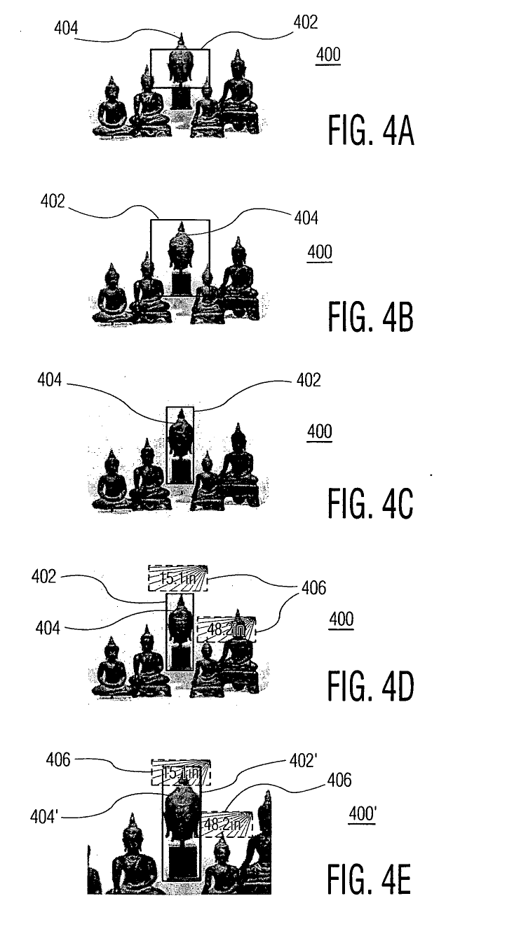

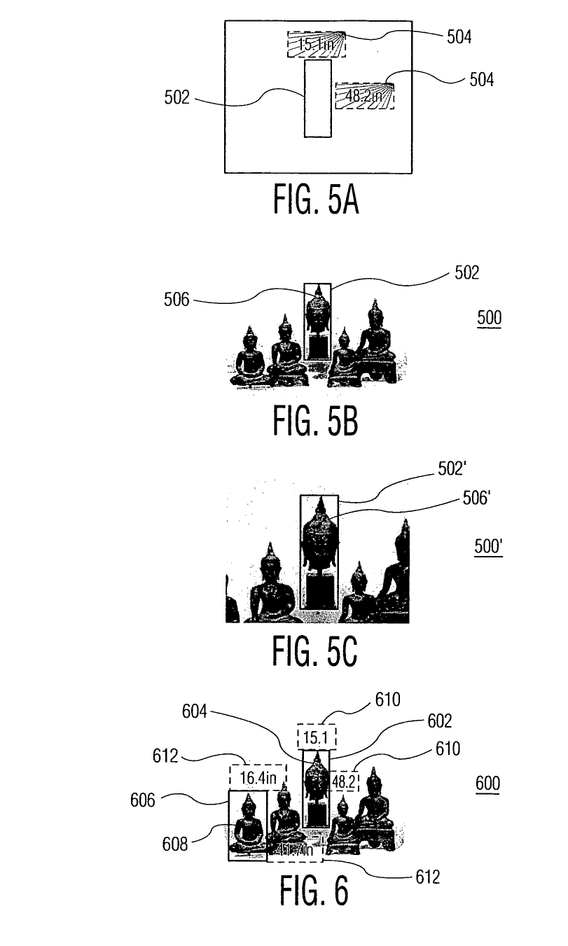

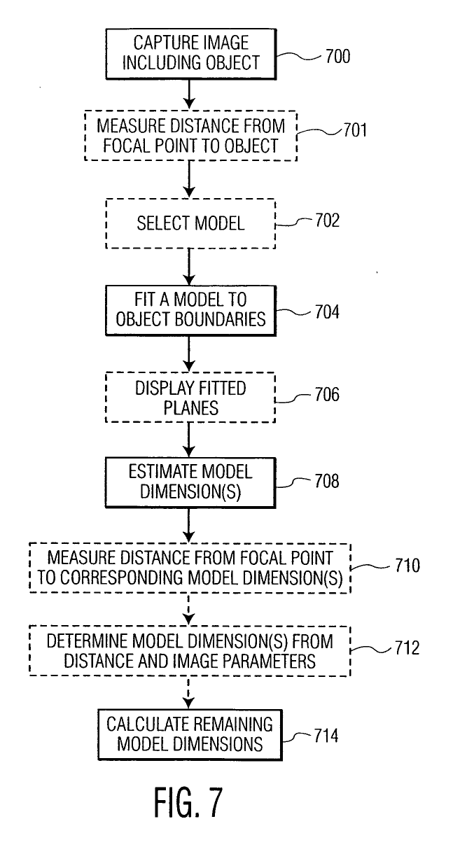

FIG. 3 is a flowchart illustrating an exemplary method for measuring a size of an object in a field of view of an image according to the present invention. In step 300, one of three operating modes for measuring a size of the object is selected: an interactive mode, an interactive object size tracking mode and a post-processing mode. FIGS. 4A-4E illustrate an example of the interactive mode (steps 302-310 in FIG. 3); FIGS. 5A-5C illustrate an example of the interactive object size tracking mode (steps 312-322 in FIG. 3); and FIG. 6 illustrates an example of the post-processing mode (steps 324-332 in FIG. 3).

If the interactive mode is selected, step 300 proceeds to step 302. Referring to FIGS. 4A-4E, in step 302, an image 400 is captured including an object 404. In step 304, a distance from the focal point of imager 102 (FIG. 1) to the object is measured, for example with telemetry sensor 104 (FIG. 1). The measured distance may optionally be inserted in display 108 of exemplary system 100 (FIG. 1). Although steps 302 and 304 are illustrated as being performed separately, it is contemplated that step 304 may be performed in conjunction with step 302.

In step 306, a cursor 402 is positioned over the object 404 in captured image 400, FIG. 4A. In FIG. 4B, the cursor 402 is adjusted in a vertical dimension over the object 404. In FIG. 4C, the cursor 402 is adjusted in the horizontal dimension over the object 404. Although FIGS. 4B and 4C illustrate independent adjustments of the cursor in the horizontal and vertical dimensions to fit the cursor to the object, it is contemplated that both adjustments may be provided in a single operation or that further adjustments may be made. It is also contemplated that only a portion of the object may be selected, for example to measure only a head of the statue shown as object 404. Although the cursor is shown as being two-dimensional in FIGS. 4A-4E, it is contemplated that a one-dimensional or three-dimensional cursor may be used.

Referring back to FIG. 3, in step 308, the object size is estimated by processing the measured distance of step 304 with the known image parameters (e.g. focal distance and zoom factor) and the fitted cursor using simple geometry known by one of skill in the art. Referring to FIG. 4D, the cursor size 402 and estimated size information 406 may be superimposed on the captured image 400 when the picture is displayed by display 108 (FIG. 1) or on a remote device having compatible software. Referring back to FIG. 3, in step 310, the measured distance (step 304), the cursor size (step 306) and the estimated object size (step 308) may be stored with the image, for example in storage means 112 (FIG. 1).

Referring to FIG. 4E, if the imager 102 includes a zoom function and the zoom is operated, the shape of the cursor fitted in step 306 (FIG. 3) is desirably resized based on the known zoom factor. As shown in the figure, the resized cursor 402′ has increased in size to correspond to the increased size of object 404′ of zoomed captured image 400′.

Referring back to FIG. 3, if the interactive object size tracking mode is selected, step 300 proceeds to step 312. Referring to FIGS. 5A-5C, in step 312, a target object size is entered, for example using control interface 110 (FIG. 1). The entered information providing a target object having a predetermined size. This mode may be useful when a known size is useful for finding an object. For example, a user may be shopping in a store and looking for an object (for example, a lamp or a picture frame) of a particular size that may fit in a specific bookshelf.

In step 314, an image 500 is captured including an object 506. In step 316, a distance from the focal point of imager 102 (FIG. 1) to the object 506 is measured, for example with telemetry sensor 104 (FIG. 1). Although steps 314 and 316 are illustrated as being performed separately, it is contemplated that step 316 may be performed in conjunction with step 314.

In step 318, the cursor is adjusted to equal the target object size. The measured distance (step 316), the known image parameters and the predetermined size of the target object (step 312) are used to adjust the size of the cursor, as shown in FIG. 5A. Although the cursor is shown as being two-dimensional in FIGS. 5A-5C, it is contemplated that a one-dimensional or three-dimensional cursor may be used.

In step 320, the target object size is compared with the object 506 using the cursor 502. Accordingly, the cursor 502 is superimposed on the image and positioned to overlap at least a portion of the object 506, as shown in FIG. 5B. In this manner, the target object and the object 506 may be compared to estimate the size of the object. In FIG. 5B a match is made between the target object size and the object 506.

Referring back to FIG. 3, in step 322, if desired, the image with the target object size (step 312) and the captured image (step 314) may optionally be stored, for example, in storage means 112 (FIG. 1).

Referring to FIG. 5C, if the imager 102 (FIG. 1) includes a zoom function and the zoom is operated, the cursor 502 is adjusted in step 316 (FIG. 3) and desirably resized based on the known zoom factor. As shown in the figure, the resized cursor 502′ has increased in size to correspond to the increased size of object 506′ of zoomed captured image 500′.

If the post-processing mode is selected, step 300 proceeds to step 324. Referring to FIG. 6. Post-processing mode desirably allows images to be captured and stored and provides the object measurement estimate after the image is stored. Referring to FIG. 6, in step 324, an image 600 is captured including an objects 604 and 608. In step 326, a distance from the focal point of imager 102 (FIG. 1) is measured to the objects 604 and 606, for example with telemetry sensor 104 (FIG. 1). In step 328, the captured image (step 324) and the measured distance (326) are stored, for example in storage means 112 (FIG. 1). Although steps 324 and 326 are illustrated as being performed separately, it is contemplated that step 326 may be performed in conjunction with step 324.

In step 330, the size of objects 604 and 606 in stored image 600 are measured according to steps 306-308. Accordingly, cursors 602 and 606 are superimposed over respective objects 604 and 608 to measure each of the objects in the stored image 600. As shown in FIG. 6, estimated sizes 610 and 612 are superimposed on stored image 600 corresponding to objects 604 and 608. Although the cursor is shown as being two-dimensional in FIGS. 4A-4E, it is contemplated that a one-dimensional or three-dimensional cursor may be used. Although two objects are shown as being estimated for size, it is understood that only one object may be estimated in post-processing mode.

Referring back to FIG. 3, in step 332, if desired, the image with the multiple estimated object sizes (step 330), the captured image (step 314), the cursor sizes and the measured distance (step 326) may optionally be stored, for example, in storage means 112 (FIG. 1).

In post-processing mode, sizes for a plurality of objects may be estimated by creating further cursors anywhere in the field of view of the stored image 600. It is understood that the distance measure is relative to the center of the field of view and all object sizes may be estimated using a common scale factor. Accordingly, images having objects at approximately a same distance from the focal point may be estimated with respect to size.

Object Size Measurement Using Model Fitting

Referring back to FIG. 1, in a further exemplary embodiment, system 100 includes a model database 114 for storing models with which to model the object in the captured image. The models in model database 114 may include two-dimensional models as discussed above or three-dimensional models such as a rectangular prism, a cylinder and a sphere. It is contemplated that any polygon may be used as a two-dimensional model to model the object.

According to the further exemplary embodiment processor 106 receives the captured image from imager 102 and is configured to fit a model from model database 114 to the boundaries of the object in the captured image. Processor 106 may configure display 108 to display the captured image from imager 102 and the fitted model. The fitted model desirably includes dimensions that correspond to the boundaries of the object.

The control interface 110 may be used in the further exemplary embodiment for entering at least one dimension of the fitted model displayed by the display 108. Alternatively, the telemetry sensor 104 may measure a distance from the focal point to the object where the distance corresponds to at least one dimension of the fitted model. The dimension to be estimated may include one or more of a height a width and a depth of the fitted model.

The processor 106 desirably determines all of the dimensions of the fitted model using either the estimated dimension entered using control interface 110 or alternatively using the measured distance measured by the telemetry sensor 104. In addition, the processor 104 uses the known image parameters from imager 102 and the fitted model provided by processor 106 to determine all of the dimensions of the fitted model of the object.

In the further exemplary embodiment, processor 106 may configure the display 108 to show the object or the fitted model with the determined dimensions. For example, the object and the captured image may be displayed with the determined dimensions. Alternatively, the object and the fitted model may be presented in the captured image as well as the determined dimension. Furthermore, only the fitted model and the determined dimensions may be presented without the captured image. Processor 106 may configure the display to present a horizontal and/or vertical scale of the object in the captured image based on the determined dimensions of the fitted model. The determined dimensions and the captured image may be stored in storage means 112.

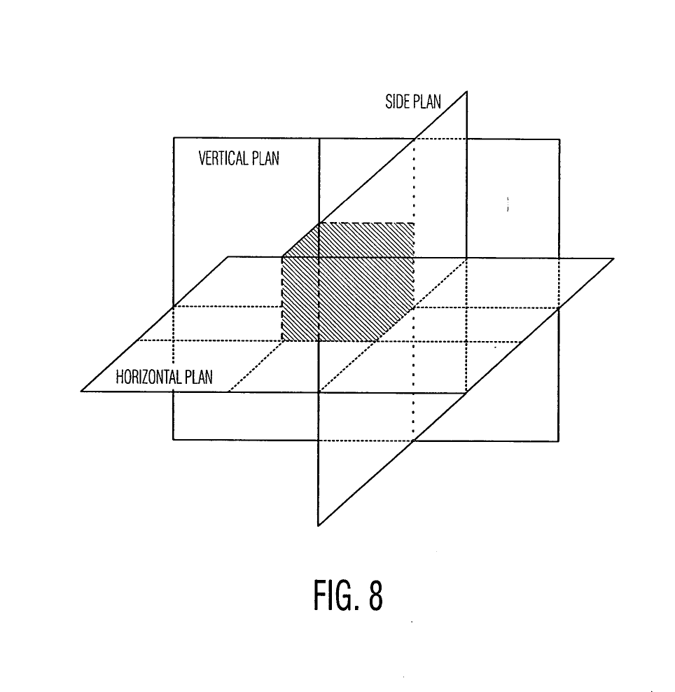

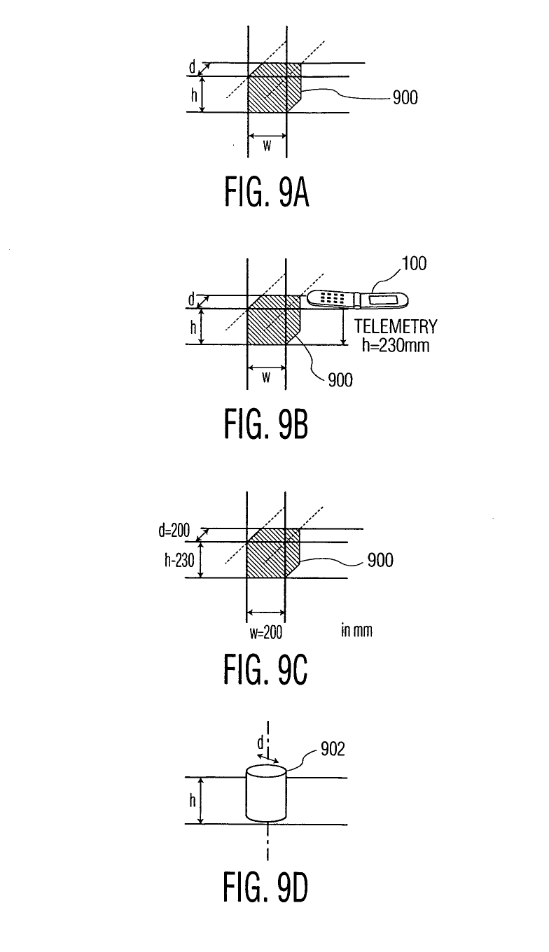

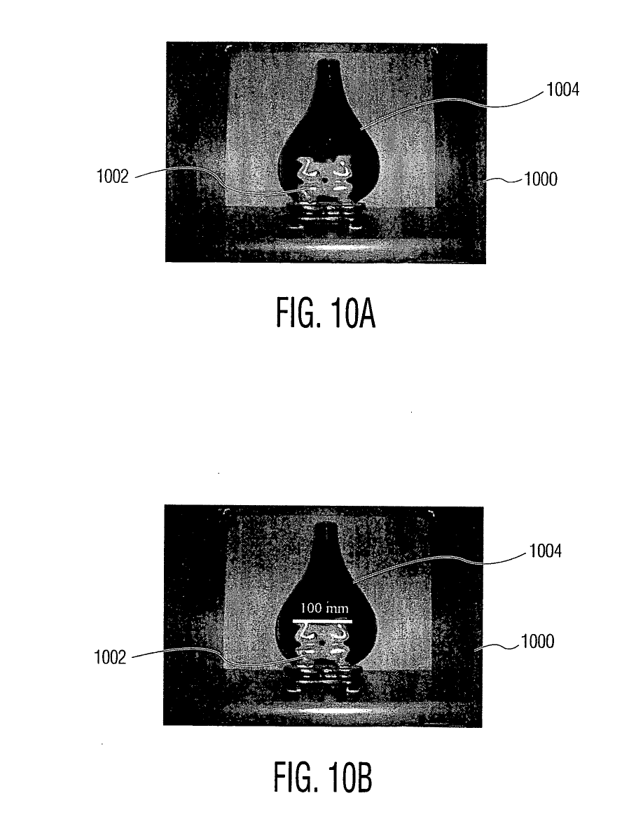

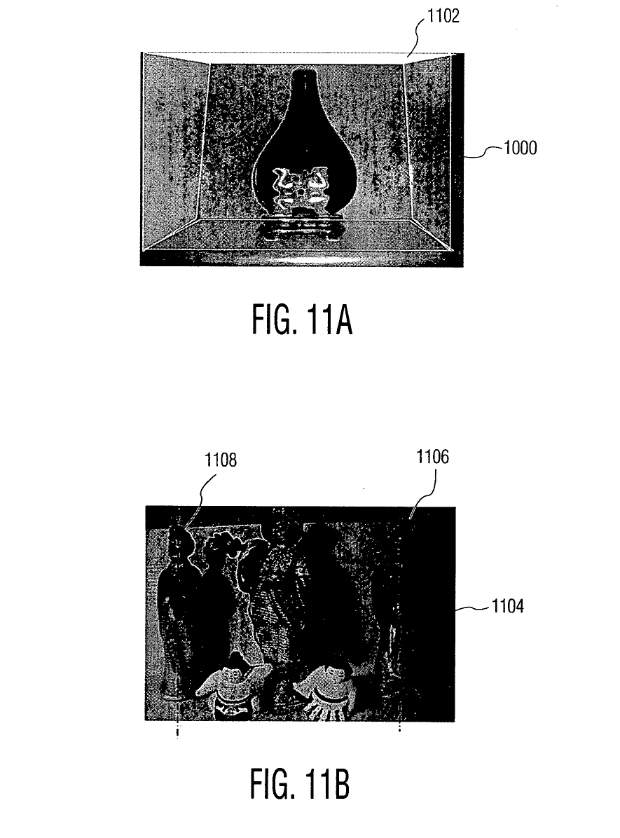

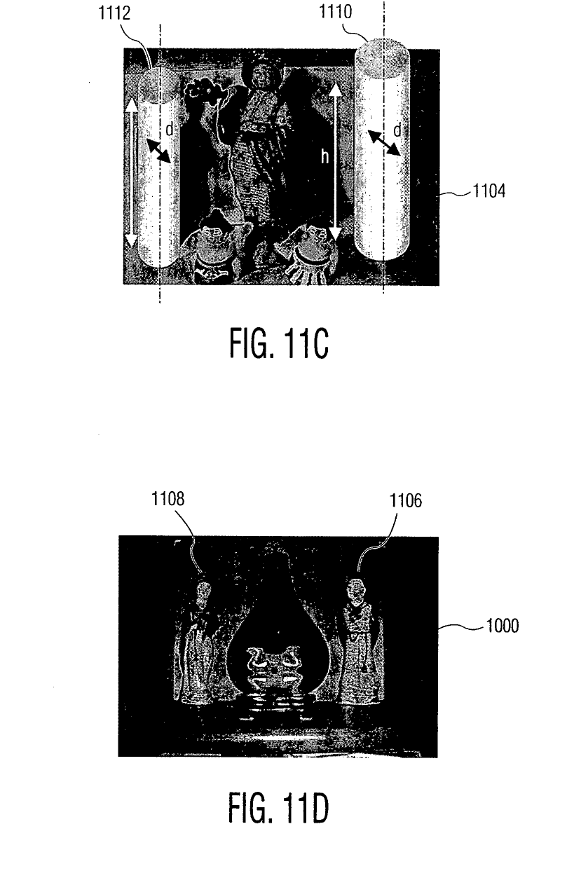

FIG. 7 is a flowchart illustrating the exemplary method for measuring a size of an object in a field of view of an image using the model database 114 (FIG. 1). Referring generally to the figures: FIG. 8 illustrates an example of estimated planes corresponding to an object according to the exemplary method using a fitted model; FIGS. 9A-9D illustrates an example of measuring a size of an object according to the exemplary method using the fitted model; FIGS. 10A and 10B illustrate an example of providing a scale relative to an object using the estimated size of the object according to the exemplary method using the fitted model; and FIGS. 11A-11D illustrate an example of embedding an object with a size measured according to the exemplary method using the fitted model in a further image such that the scale of the object corresponds to the dimensions of the further image.

Referring to FIG. 7, in step 700, an image is captured that includes the object. In optional step 702, a model may be selected manually by a user. The model may be selected, for example, from one of a rectangular prism, a cylinder or a sphere. The user desirably superimposes the selected model on the captured image (step 700). The user may further position and/or adjust the selected model to fit the model to the object. It is contemplated that the model may be downloaded, for example, via the Internet, using the control interface 110 (FIG. 1). It is understood that the model may be selected from any remote location using an appropriate interface. Optionally, in step 701, the distance from the focal point of imager 102 (FIG. 1) to the object may be measured after the image is captured. It is contemplated that optional step 701 may be performed in conjunction with step 700. The distance measured in step 701 may be used to get a coarse estimate of the object size. Steps 708 and optional steps 710 and 712 may be used to provide a more precise estimation of the object size.

In step 704, a model is automatically selected by the processor 106 (FIG. 1) from model database 114 (FIG. 1) and fitted by the processor 106 (FIG. 1) to the boundaries of the object. The fitted model desirably has dimensions that correspond to the boundaries of the object. An example model of an object is shown in FIGS. 9A-9C. The model may be presented on display 108 (FIG. 1) semi-transparently over the object. The user may optionally acknowledge the fitted model or switch to manual mode (step 702) to select another model, for example by using control interface 110 (FIG. 1).

Referring to FIG. 8, the processor 106 (FIG. 1), may optionally present fitted planes to the object on display 108 (FIG. 1). As part of the model fitting process, the processor 106 (FIG. 1), desirably detects planes corresponding to the object. In an exemplary embodiment, these planes are horizontal and vertical planes. It is contemplated that other planes may be used. In the example shown in FIG. 8, for a rectangular prism, three perpendicular planes are determined.

Referring to FIGS. 9A-9D, in step 708, at least one dimension among the dimensions is estimated. The processor 106 (FIG. 1), defines dimensions to be estimated and presents them as shown in FIG. 9A. For example, for the rectangular prism model 900 shown in FIG. 9A, a height (h), a width (w) or a depth (d) may be presented for estimation. Alternatively, the model may be a cylinder 902, as shown in FIG. 9D, and the dimensions of cylinder 902 for estimation may include height (h) and diameter (d). Similar dimensions may be presented for a spherical model (not shown).

The processor 106 (FIG. 1) prompts the user to enter one or more of the dimensions shown in FIG. 9A of model 900. In step 708, the user may manually enter an estimation of one or more of the presented dimensions, for example using control interface 110 (FIG. 1). It is contemplated that the estimated one or more dimensions may be obtained using the control interface 110 (FIG. 1) via, for example, the Internet. It is understood that the estimated dimensions may be obtained from any source using an appropriate interface. It is further contemplated that a user may enter a calibration element in the captured image, for example using control interface 110 (FIG. 1). If the size of the calibration element is provided, the processor 106 (FIG. 1) may use the calibration element size when performing dimension calculations.

In optional steps 710 and 712, one or more dimensions may be estimated using telemetry sensor 104 (FIG. 1). In step 710, the distance from the focal point of imager 102 (FIG. 1) to the object corresponding to the one or more dimensions. For example, FIG. 9B shows that telemetry sensor (not shown) in exemplary system 100 may be used to measure the distance corresponding to height (h) of model 900. In step 712, the corresponding model dimension is estimated by processing the measured distance, the known image parameters and the fitted model 900 (FIG. 9B).

Any of the presented dimensions may be used to measure the corresponding dimension using the telemetry sensor 104 (FIG. 1). It is contemplated that some corresponding dimensions may be easier for a user to measure than other dimensions by the user and thus providing the user selection of the presented dimensions may reduce a burden on the user.

In an exemplary embodiment, the processor 106 (FIG. 1) configures the display 108 to present the different dimensions in a circular buffer. When a dimension is selected, the selected dimension may blink on display 108 (FIG. 1) to provide visual feedback to the user that the selection is made. The user may then enter the telemetry distance or the manually estimated dimension.

In step 714, the dimensions of the fitted model are determined, based on the estimated one or more dimensions and the fitted model, using known in the art geometrical relationships. Referring to 9C, in model 900, the height is estimated using steps 708 or steps 710-712. The remaining depth and width dimensions are desirably calculated by processor 106 (FIG. 1). The estimated and calculated dimensions are desirably presented on display 108 (FIG. 1) with the estimated dimension and the remaining calculated dimensions displayed with different colors. Accordingly, the presented dimensions with different colors provide visual feedback. The estimated and calculated dimensions may represent different precision measurements with the calculated dimensions being more prone to error than the estimated dimensions.

Although not shown in FIGS. 9A-9C, it is understood that a plurality of objects may be modeled according to the exemplary method illustrated in FIG. 7. A user may be prompted to measure the plurality of fitted models corresponding to the plurality of objects in a captured image. The user may select an order for providing estimated dimensions for each of the objects. In an exemplary embodiment, the processor 106 (FIG. 1) measures objects across the field of view of the captured image. A different measurement order may be selected using control interface 110 (FIG. 1).

For each object, the dimension(s) to be estimated can be selected from dimensions stored in a circular buffer by processor 106 (FIG. 1). The processor 106 (FIG. 1) may automatically calculate the remaining dimensions for the object and prompt the user for the next measure to be entered.

Control interface 110 (FIG. 1) may be used to overwrite estimated and/or calculated dimensions. The processor 106 (FIG. 1) may then recalculate the remaining dimensions for the object(s) in the captured image.

The determined dimensions for one or more objects may be stored with the image, for example in storage means 112 (FIG. 1). The dimensions and the captured image are desirably stored in a format that is readable by other devices capable of reading images.

FIGS. 10A and 10B illustrate an example of providing a scale relative to an object using the estimated size of the object according to the exemplary method illustrated in FIG. 7. in FIG. 10, a captured image 1000 includes an object 1002. The exemplary method described with respect to FIG. 7 may be used to determine the dimensions of object 1002. In FIG. 10B, the dimensions may be presented on captured image 1000 as a horizontal scale, for example, to represent a ruler. It is contemplated that a vertical and/or a horizontal scale may be presented to correspond to the object or a plurality of objects in a captured image.

FIGS. 11A-11D illustrate an example of embedding objects 1106 and 1108 of a further image 1104 in a stored image 1100. In this example, the scale of the object corresponds to the dimensions of the stored image based on the determined dimensions of objects 1106 and 1108 measured according to the exemplary method illustrated in FIG. 7. Referring to FIG. 11A, an image 1000 is captured and stored. The processor 106 (FIG. 1) fits a model 1102 to image 1000. The model 1102 represents the space of the bookshelf shown in image 1000. It is a model of a box, delimited by six planes. The processor 106 (FIG. 1), desirably prompts the user to measure the box according to the method described above. The dimensions are then stored along with image 1000.

In FIG. 11B, an image 1104 is captured having objects of interest 1106 and 1108 that may be placed in the bookshelf of image 1000. One or more cursors may be positioned in a window for modeling the objects. The objects of interest 1106 and 1108 are shown in FIG. 11B with respective dashed lines.

In FIG. 11C, objects 1106 and 1108 are fitted to respective cylindrical models 1110 and 1112 and the user is prompted to measure their respective dimensions, as described above. The fitted models 1110 and 1112, the objects 1106 and 1108 and their respective dimensions are desirably stored by processor 106 (FIG. 1), for example, in storage means 112 (FIG. 1).

In FIG. 11D, the processor 106 (FIG. 1) may embed the objects 1106 and 1108 in image 1000 with the corresponding scale of image 1000. The processor 106 (FIG. 1) may calculate the dimensions according to the depth of the image and the image perspective.

The present invention desirable allows pictures to be used as a metrological tool. The exemplary instrumented pictures may include object dimensions similar to technical drawings. Accordingly, the present invention may be used by, for example, architects, contractors, real-estate agents or homeowners, to obtain measurements, for example, of houses, properties, or any object in a picture. Another application may be for advertising or selling objects, such as using eBay where pictures are used to gauge the dimensions of an object.

Furthermore, the present invention may allow for objects from one picture to be inserted into another picture while maintaining appropriate scale factors. Such an application may be used, for example, when shopping so that a user may visualize the object in the context of where the object may be placed, such as a shelf. Accordingly, users may visualize, for example, a potential sofa in their living room and gauge the size as well as the compatibility of the color scheme.

Although the invention has been described in terms of apparatus for measuring a size of an object, it is contemplated that one or more components may be implemented in software on microprocessors/general purpose computers (not shown). In this embodiment, one or more of the functions of the various components may be implemented in software that controls a general purpose computer. This software may be embodied in a computer readable carrier, for example, a magnetic or optical disk, a memory-card or an audio frequency, radio-frequency, or optical carrier wave.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for measuring a size of an object in a field of view of an image having image parameters, the method comprising the steps of:
a) capturing the image including the object;
b) measuring a distance from a focal point of the image to the object;
c) fitting a cursor to the object; and
d) processing the measured distance, the image parameters and the cursor to estimate the size of the object.

2. The method according to claim 1, wherein the image parameters include a focal length and a zoom factor.

3. The method according to claim 1, prior to step (d), comprising the steps of:
indicating the object in the captured image; and
processing the indicated object to fit the cursor to a shape of the indicated object.

4. The method according to claim 1, wherein a size of the cursor is adjustable in at least one dimension.

5. The method according to claim 1, further including the steps of:
displaying the object with the cursor and the estimated size superimposed on the image;
changing a size of the displayed image according to a zoom factor; and
resizing the superimposed cursor based on the zoom factor.

6. The method according to claim 1, step (c) including the steps of:
c1) superimposing the cursor on the captured image; and
c2) at least one of positioning the cursor and adjusting a size of the cursor to fit the cursor to the object in the captured image.

7. The method according to claim 6, further comprising the step of storing the captured image, the measured distance, the positioned or adjusted cursor and the estimated size of the object.

8. The method according to claim 1, prior to step (c), comprising the step of providing a target object having a predetermined size and step (d) further comprising the steps of:
processing the measured distance, the image parameters and the predetermined size of the target object to adjust a size of the cursor to be the same as the predetermined size of the target object;
superimposing the adjusted cursor on the image and positioning the adjusted cursor to overlap at least a portion of the object; and
comparing the target object and the object using the positioned cursor to estimate the size of the object.

9. The method according to claim 1, step (c) including the steps of:
c1) storing the captured image with the measured distance;
c2) superimposing the cursor on the stored image; and
c3) at least one of positioning the cursor and adjusting a size of the cursor to fit the cursor to the object in the stored image,
wherein step (d) operates on the stored image.

10. The method according to claim 9, wherein the object includes a plurality of objects and the method further includes repeating steps (c2), (c3) and (d) to estimate the respective sizes of the plurality of objects.

11. The method according to claim 1, prior to step (b), comprising the step of selecting at least one of a type of the cursor, a transparency of the cursor and a dimensionality of the cursor,
wherein the dimensionality of the cursor is selected from one of one dimensional, two dimensional, and three dimensional,
the type of the cursor is selected from one of a rectangle, a circle or a cross, and
the transparency of the cursor is selected from semi-transparent, transparent and opaque.

12. Apparatus for measuring a size of an object in a field of view of an image, the apparatus comprising:
an imager which captures the image including the object, the imager providing image parameters corresponding to the captured image;
a telemetry sensor which measures a distance from a focal point of the imager to the object;
a display which displays the captured image and a cursor having a size and a position that are each adjustable for designating at least a portion of the object; and
a processor configured to process the measured distance from the telemetry sensor, the image parameters from the imager, and the size of the cursor to estimate the size of the object.

13. Apparatus according to claim 12, further comprising storage means for storing the captured image from the imager, the measured distance from the telemetry sensor, the size of the cursor from the display and the estimated size of the object from the processor.

14. Apparatus according to claim 12, wherein the processor and the display are configured to display the cursor selected from the group consisting of a one dimensional cursor, a two dimensional cursor, a three dimensional cursor, a rectangular cursor, a circular cursor, a cross-shaped cursor, a transparent cursor, a semi-transparent cursor and an opaque cursor.

15. Apparatus according to claim 12, wherein the display further displays the estimated size estimated by the processor superimposed on the captured image.

16. Apparatus according to claim 12, wherein the image parameters include a focal length and a zoom factor.

17. Apparatus according to claim 12, wherein the processor includes an object fitting algorithm and adjusts a shape of the cursor to correspond to a shape of the object determined by the object fitting algorithm.

18. Apparatus according to claim 12, further comprising a control interface for adjusting at least one of the position and the size of the cursor,
wherein the cursor is adjustable in at least one dimension.

19. Apparatus according to claim 18, wherein the processor includes software to adjust the size of the cursor according to a predetermined size.

20. Apparatus according to claim 18, wherein the control interface is configured to provide selection of at least one of a type of the cursor, a transparency of the cursor and a dimensionality of the cursor.

21. A method for measuring a size of an object in a field of view of an image having image parameters, the method comprising the steps of:
a) capturing the image including the object;
b) fitting a model of the object to boundaries of the object, the fitted model having dimensions corresponding to the boundaries of the object;
c) estimating at least one dimension among the dimensions of the fitted model; and
d) determining the dimensions of the fitted model based on the estimated at least one dimension, the image parameters and the fitted model to estimate the size of the object.

22. A computer-readable carrier including computer program instructions that cause a computer to perform the method according to claim 21.

23. The method according to claim 21, prior to step (b), comprising the steps of:
selecting the model from one of a rectangular prism, a cylinder or a sphere;
superimposing the selected model on the captured image; and
at least one of positioning and adjusting the selected model to fit the model to the object,
wherein step (b) is responsive to the selected and adjusted model.

24. The method according to claim 21, wherein the at least one dimension is selected from at least one of a height, a width, a depth and a diameter of the fitted model.

25. The method according to claim 21, wherein the object includes a plurality of objects and the method further comprises repeating steps (b)-(d) to determine the dimensions of the respective plurality of objects.

26. The method according to claim 21, step (b) further includes the step of superimposing the fitted model on the object in the captured image where the model is selected from one of a rectangular prism, a cylinder and a sphere.

27. The method according to claim 21, further comprising the step of presenting at least one of the object and/or the fitted model with the determined dimensions.

28. The method according to claim 21, further comprising the steps of:
providing a further dimension to overwrite a respective one of the determined dimensions determined in step (d); and
recalculating remaining dimensions according to the further dimension.

29. The method according to claim 21, further comprising the step of presenting at least one of a horizontal and vertical scale of the object on the captured image based on the determined dimensions of step (d).

30. The method according to claim 21, step (c) including the steps of:
measuring a distance from a focal point of the image to the object corresponding to the at least one dimension;
processing the measured distance, the image parameters and the fitted model to estimate the at least one dimension; and
step (d) includes the step of computing the remaining dimensions of the modeled object using the estimated at least one dimension.

31. The method according to claim 21, further comprising the step of textually displaying the estimated at least one dimension and the computed remaining dimensions on the captured image, each dimension being displayed using a respective different color.

32. The method according to claim 21, further comprising the step of storing the determined dimensions of the object and the captured image.

33. The method according to claim 32, further comprising the steps of:
repeating steps (a)-(d) to determine further dimensions corresponding to a further object in a further image; and
inserting the further object from the further image in the stored image such that the determined further dimensions of the further object correspond to the determined dimensions of the object in the stored image.

34. Apparatus for measuring a size of an object in a field of view of an image, the apparatus comprising:
an imager for capturing the image including the object, the imager including image parameters corresponding to the captured image;
a model database for storing models of the object;
a display for displaying the captured image from the imager and a fitted model of the object, the fitted model having dimensions corresponding to boundaries of the object; and
an indicator for entering at least one dimension of the fitted model displayed by the display; and
a processor configured to 1) fit the model to the boundaries of the object to form the fitted model using one of the models selected from the model database and the captured image from the imager and 2) to determine the dimensions of the fitted model based on the entered at least one dimension by the indicator, the image parameters from the imager and the fitted model fitted by the processor.

35. Apparatus according to claim 34, wherein the indicator includes a telemetry sensor for measuring a distance from a focal point of the imager to the object corresponding to the at least one dimension and the processor determines the at least one dimension based on the measured distance, the image parameters and the fitted model.

36. Apparatus according to claim 34, further comprising storage means for storing the determined dimensions of the object determined by the processor and the captured image from the imager.

37. Apparatus according to claim 34, wherein the models in the model database includes models of a rectangular prism, a cylinder and a sphere.

38. Apparatus according to claim 34, wherein the display presents at least one of the object and/or the fitted model with the determined dimensions.

39. Apparatus according to claim 34, wherein the display presents at least one of a horizontal and vertical scale of the object in the captured image, the at least one of a horizontal and vertical scale determined by the processor based on the determined dimensions of the fitted model.
